(19) United States
(12) Patent Application Publication
(10) Pub. No.: US 2014/0025367 A1
(43) Pub. Date: Jan. 23, 2014

(54) PREDICTIVE TEXT ENGINE SYSTEMS AND RELATED METHODS

(71) Applicant: Gregory A. Dunko, Cary, NC (US)

(72) Inventor: Gregory A. Dunko, Cary, NC (US)

(73) Assignee: HTC CORPORATION, Taoyuan City (TW)

(21) Appl. No.: 13/551,736

(22) Filed: Jul. 18, 2012

(51) Int. Cl. G06F 17/27

(52) U.S. Cl. 704/9

(57) ABSTRACT

Predictive text engine systems and related methods are provided. In this regard, a representative system includes: a mobile device operative to communicate information via a communications network, the mobile device having a user interface, a context analysis system and a predictive text engine; the user interface being operative to receive user input to generate a text-based communication; the context analysis system being operative to determine a context of the text-based communication and to request, via the communications network, information corresponding to the context to enhance performance of the predictive text engine; the predictive text engine being operative to predict text corresponding to the user input based, at least in part, on the information corresponding to the context and received responsive to the request.

### TECHNICAL FIELD

The present disclosure generally relates to predictive text engines.

### BACKGROUND

Mobile devices with limited user interfaces are heavily used for text communications such as SMS, email and social networking updates, for example. Some devices utilize a dedicated QWERTY keyboard solution to facilitate text entry. Other devices use a “soft” keyboard on a touch display, and even others use numeric keys and “multi-tap” functionality for selecting letters of interest. For instance, a second “tap” on the number “2” may correspond to the letter “e”.

In smaller devices (especially those that do not have a dedicated keyboard), software algorithms and applications are used to predict characters or words in a text message. By way of example, a word prediction approach may be used, in which the device has a stored library of words and word usage patterns. The device uses the library to predict next words based on previous words in the message. The stored library “evolves” by storing the speech patterns and word choices of a specific user and thus improves over time.

### SUMMARY

Predictive text engine systems and related methods are provided. Briefly described, one embodiment, among others, is a text prediction system comprising: a mobile device operative to communicate information via a communications network, the mobile device having a user interface, a context analysis system and a predictive text engine; the user interface being operative to receive user input to generate a text-based communication; the context analysis system being operative to determine a context of the text-based communication and to request, via the communications network, information corresponding to the context to enhance performance of the predictive text engine; the predictive text engine being operative to predict text corresponding to the user input based, at least in part, on the information corresponding to the context and received responsive to the request.

Another embodiment is a text prediction system comprising: a context analysis system operative to receive, via a communications network, information corresponding to a text-based communication from a mobile device; and contextual sub-libraries of words communicating with the context analysis system; the context analysis system being further operative to communicate information corresponding to a first of the contextual sub-libraries to the mobile device responsive to determining that the information corresponding to the text-based communication from the mobile device corresponds to the context of the words included in the first of the contextual sub-libraries.

Another embodiment is a method for predicting text in a mobile device comprising: receiving a user input corresponding to a text-based communication; determining a context of the text-based communication; requesting, via a communications network, information corresponding to the context; and predicting text corresponding to the user input based, at least in part, on the information corresponding to the context and received responsive to the request.

Other systems, methods, features, and advantages of the present disclosure will be or may become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram of an example embodiment of a predictive text engine system.

FIG. 2 is a flowchart depicting an example embodiment of a method for predicting text in a mobile device.

FIGS. 3A-3C are schematic diagrams depicting representative functionality of an example embodiment of a predictive text engine system.

FIG. 4 is a schematic diagram depicting another example embodiment of a predictive text engine system.

FIG. 5 is a schematic diagram depicting an example embodiment of a mobile device.

### DETAILED DESCRIPTION

Having summarized various aspects of the present disclosure, reference will now be made in detail to that which is illustrated in the drawings. While the disclosure will be described in connection with these drawings, there is no intent to limit the scope of legal protection to the embodiment or embodiments disclosed herein. Rather, the intent is to cover all alternatives, modifications and equivalents included within the spirit and scope of the disclosure as defined by the appended claims.

In this regard, predictive text engine systems and related methods are provided, some embodiments of which involve the use of context analysis systems that are resident on mobile devices (e.g., smartphones) that are able to determine a context of the text-based communication. For instance, in such a mobile device, the context analysis system may be able to determine the context of a text message that the user of the device is drafting and then request information corresponding to the context to enhance performance of an onboard predictive text engine. In this manner, the limited library of words typically accessed by a mobile device may be dynamically altered based on the usage of the device.

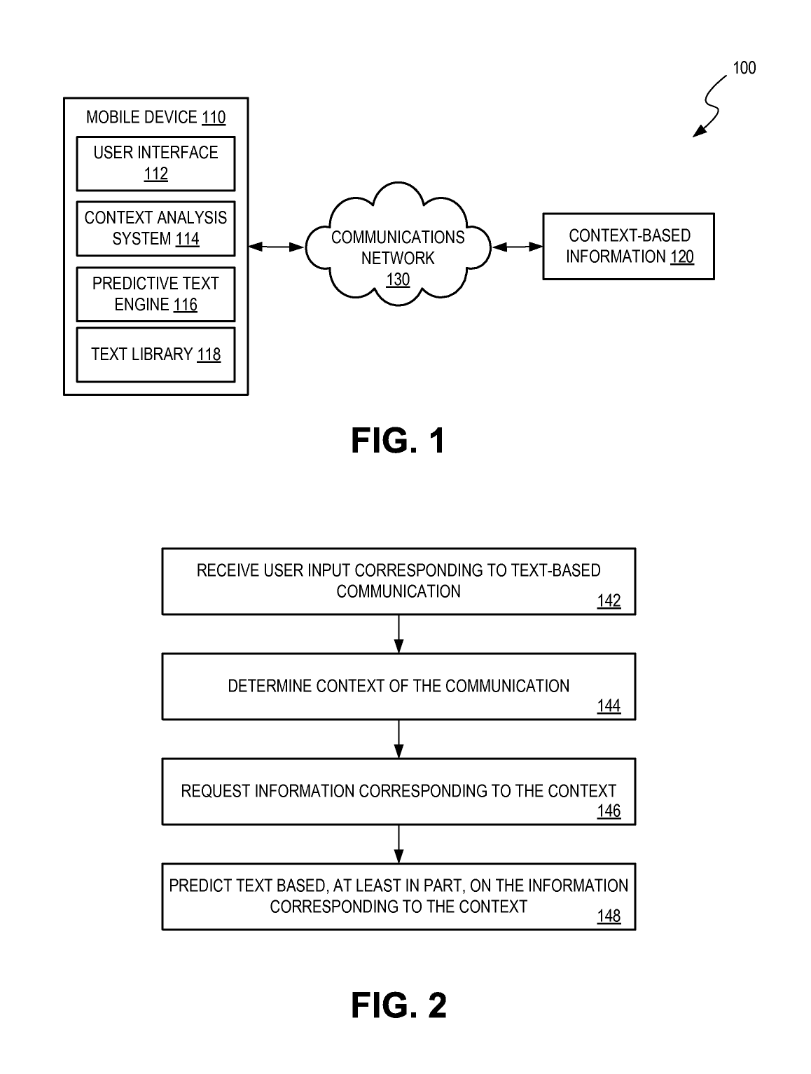

FIG. 1 is a schematic diagram of an example embodiment of a predictive text engine system. As shown in FIG. 1, system 100 includes a mobile device 110 and context-based information 120. The context-based information, which may be configured as a sub-library of words organized by context, may be communicated to the mobile device via communications network 130. Notably, the communications network may incorporate one or more wired or wireless networks that may utilized one or more communications protocols.

Mobile device 110 (e.g., a smartphone) includes a user interface 112, a context analysis system 114, a predictive text engine 116 and a text library 118. In operation, the user interface facilitates input by a user to generate a text-based communication such as a text message or an email. The user interface may incorporate one or more of various components such as a touchscreen, soft keys and a key pad, for example.

Context analysis system 114 monitors the information input via the user interface and endeavors to determine a context associated with the information. Responsive to determining such a context, the context analysis system enables a request for information to be sent via the communications network. In particular, the request for information is directed to context-specific information that may enhance the performance of the predictive text engine.

Predictive text engine 116 is operative to predict text corresponding to the user input. By way of example, the predictive text engine may cause a word to be displayed to the user that is predicted based a portion of the word being input. Thus, the predictive text engine may provide a convenient means for generating a portion of the text-based communication without the user having to manually input every letter of every word. Selection of a predicted word is accomplished by the predictive text engine accessing text library 118, which is resident on the mobile device.

Responsive to the request for information, the mobile device of FIG. 1 receives context-based information 120, such as via an associated server (not shown), via the communications network. In this embodiment, the information 120 is configured as a sub-library of words, with the words being associated with the context determined by the context analysis system. Once updated with the context-based information, the predictive text engine may be able to provide more relevant predicted text, thereby reducing the predicted text error rate and enhancing the user's experience with the mobile device.

FIG. 2 is a flowchart depicting an example embodiment of a method for predicting text in a mobile device, such as may be performed by predictive text engine system 100 of FIG. 1. As shown in FIG. 2, the method involves receiving a user input corresponding to a text-based communication (block 142). For instance, the user input may correspond to at least a portion of a word input to the mobile device via soft keys.

In block 144, a context of the text-based communication is determined. In some embodiments, this may be performed by a system resident on the mobile device or on a separate device, such as a server that implements functionality associated with a context analysis system. In block 146, information corresponding to the determined context is requested via a communications network. Then, such as depicted in block 148, text corresponding to the user input is predicted based, at least in part, on the information corresponding to the context that was received responsive to the request. Notably, the predicted text may be displayed to the user via a display of the mobile device while the user is providing additional inputs. As such, the context information may be used to enhance the intuitive word completion feature of the mobile device.

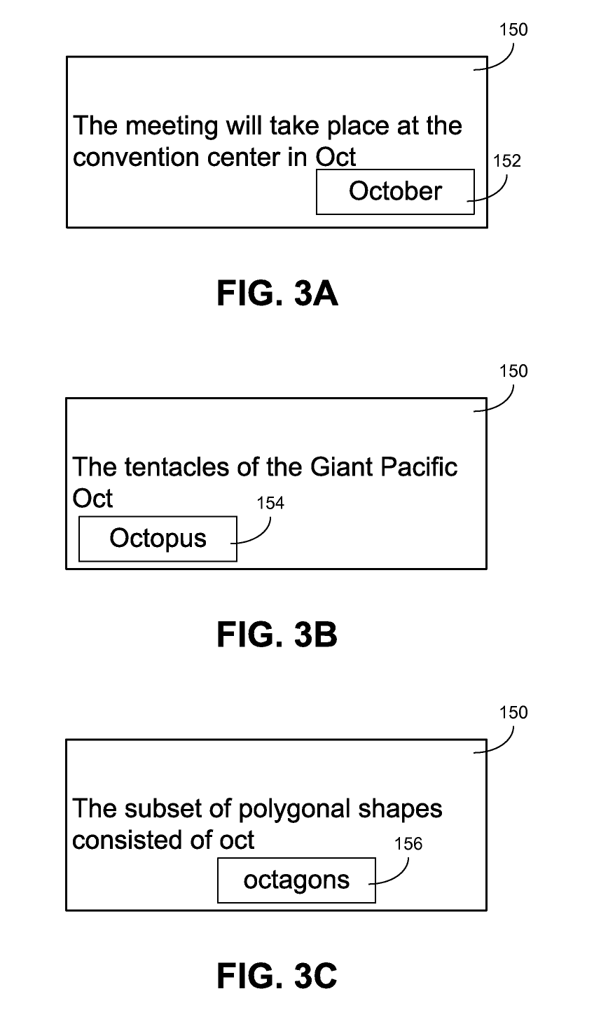

FIGS. 3A-3C are schematic diagrams depicting representative functionality of an example embodiment of a predictive text engine system. Specifically, FIGS. 3A-3C depict a representative display screen 150, which is displaying different text-based communications being input by a user at different times.

In FIG. 3A, the user has input “The meeting will take place at the convention center in Oct”. Responsive to this input, the predictive text engine accesses the resident text library and predicts that the user is attempting to input the word “October”. The word “October” is then displayed as an option 152, which the user may select for inclusion in the text-generated communication without having to input the remaining letters “ober”.

In contrast, in FIG. 3B, the user has input “The tentacles of the Giant Pacific Oct”. Responsive to this input, the predictive text engine accesses the resident text library and predicts that the user is attempting to input the word “Octopus”. The word “Octopus” is then displayed as an option 154, which the user may select for inclusion in the communication without having to input the remaining letters “pus”. It should be noted that in being able to predict the usage of the word “Octopus” and associated context analysis engine of the mobile device determined that the context of the communication was associated with zoological terms, such as by keying on the word “tentacles”. As such, a sub-library of words associated with this context may have been uploaded to the mobile device, such as during the generation of the communication. In some embodiments, uploaded sub-libraries of context-based information may become permanent parts of the resident text library or may be stored temporarily.

In further contrast, in FIG. 3C, the user has input “The subset of polygonal shapes consisted of oct”. Responsive to this input, the predictive text engine accesses the text library and predicts that the user is attempting to input the word “octagon”. The word “octagon” is then displayed as an option 156, which the user may select for inclusion in the communication without having to input the remaining letters “agon”. It should be noted that in being able to predict the usage of the word “octagon” and associated context analysis engine of the mobile device determined that the context of the communication was associated with a geometric terms, such as by keying on the word “polygonal”.

Clearly, various context-based sub-libraries may be provided. By way of example, sub-libraries related to particular fields such as engineering, medicine and sports, among others may be provided. For the medicine field, for example, an associated sub-library may be triggered by one or more keywords, such as “health”, “doctor”, “sick”, and/or field-related lingo, such as “stat”, among others. As another example, a sub-library may be associated with a geographic region and, thus, may include terms associated with local landmarks, recreation, and foods, as well as local lingo. Note that while access to a sub-library may enable better prediction, use of such a sub-library may not result in an actual prediction.

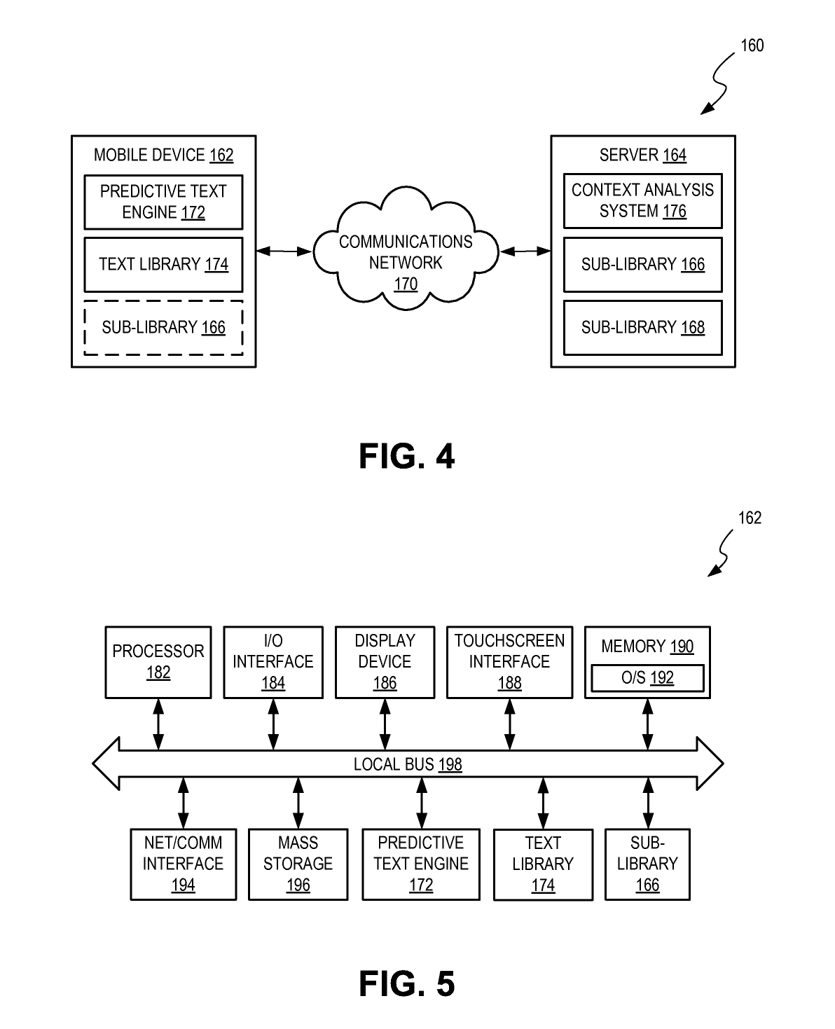

FIG. 4 is a schematic diagram depicting another example embodiment of a predictive text engine system. As shown in FIG. 4, system 160 includes a mobile device 162 and information server 164. Server 164 stores context-based information, which is configured as multiple sub-libraries of words that are organized by context. In this embodiment, only two such sub-libraries 166, 168 are shown, which sub-library 166 containing medically-related words and sub-library 168 containing engineering-related words. Communication between server 164 and mobile device 162 is facilitated by communications network 170.

Mobile device 162 includes a predictive text engine 172 and a text library 174. In operation, the mobile device communicates information corresponding to a text-based communication to server 164. Context analysis system 176 of the server receives the information and endeavors to determine a context associated with the information. Responsive to determining such a context, the context analysis system enables information corresponding to an appropriate sub-library to be communicated to the mobile device.

As shown in FIG. 4, information corresponding to sub-library 166 has been communicated from the server to the mobile device. Thus, predictive text engine 172 uses information contained in text library 174 and/or sub-library 166 to predict text corresponding to the user input.

FIG. 5 is a schematic diagram depicting an example embodiment of a mobile device. As shown in FIG. 5, mobile device 162 includes a processing device (processor) 182, input/output interfaces 184, a display device 186, a touchscreen interface 188, a memory 190, operating system 192, a network interface 194, and a mass storage 196, with each communicating across a local data bus 198. Additionally, the mobile device incorporates predictive text engine 172, text library 174 and sub-library 166.

The processing device 182 may include any custom made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 190 may include any one of a combination of volatile memory elements (e.g., random-access memory (RAM, such as DRAM, and SRAM, etc.)) and nonvolatile memory elements. The memory typically comprises native operating system 192, one or more native applications, emulation systems, or emulated applications for any of a variety of operating systems and/or emulated hardware platforms, emulated operating systems, etc. For example, the applications may include application specific software which may comprise some or all the components of the system. In accordance with such embodiments, the components are stored in memory and executed by the processing device.

Touchscreen interface 188 is configured to detect contact within the display area of the display 186 and provides such functionality as on-screen buttons, menus, keyboards, soft keys, etc. that allows users to navigate user interfaces by touch. Notably, navigating via the touchscreen interface may facilitate various functions associated with displayed content items such as searching and downloading.

One of ordinary skill in the art will appreciate that the memory may, and typically will, comprise other components which have been omitted for purposes of brevity. Note that in the context of this disclosure, a non-transitory computer-readable medium stores one or more programs for use by or in connection with an instruction execution system, apparatus, or device.

With further reference to FIG. 5, network interface device 194 comprises various components used to transmit and/or receive data over a networked environment. By way of example, such components may include a wireless communications interface. When such components are embodied as an application, the one or more components may be stored on a non-transitory computer-readable medium and executed by the processing device.

If embodied in software, it should be noted that each block depicted in the flowchart of FIG. 5 (or any of the other flowcharts) represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system. The machine code may be converted from the source code, etc. If embodied in hardware, each block may represent a circuit or a number of interconnected circuits to implement the specified logical function(s). Additionally, although the flowcharts show specific orders of execution, it is to be understood that the orders of execution may differ.

It should be emphasized that the above-described embodiments are merely examples of possible implementations. Many variations and modifications may be made to the above-described embodiments without departing from the principles of the present disclosure. By way of example, the systems described may be implemented in hardware, software or combinations thereof. All such modifications and variations are intended to be included herein within the scope of this disclosure and protected by the following claims.

At least the following is claimed:

1. A text prediction system comprising:
a mobile device operative to communicate information via a communications network, the mobile device having a user interface, a context analysis system and a predictive text engine;
the user interface being operative to receive user input to generate a text-based communication;
the context analysis system being operative to determine a context of the text-based communication and to request, via the communications network, information corresponding to the context to enhance performance of the predictive text engine;
the predictive text engine being operative to predict text corresponding to the user input based, at least in part, on the information corresponding to the context and received responsive to the request.

2. The system of claim 1, wherein:
the mobile device is operative to receive information corresponding to a first sub-library of words, the first sub-library of words being associated with the context determined by the context analysis system; and
the predictive text engine is operative to predict the text being input via the user interface based, at least in part, on the information corresponding to the first sub-library of words.

3. The system of claim 2, further comprising sub-libraries of words communicating with the communications network, the first sub-library being one of the sub-libraries.

4. The system of claim 3, wherein the sub-libraries of words are resident on a server.

5. The system of claim 1, wherein the first of the sub-libraries contains words associated with a technical field.

6. The system of claim 5, wherein the technical field is medicine.

7. The system of claim 1, wherein the first of the sub-libraries contains words associated with a geographic area.

8. The system of claim 7, wherein the first of the sub-libraries contains words associated with a local lingo.

9. A text prediction system comprising:
a context analysis system operative to receive, via a communications network, information corresponding to a text-based communication from a mobile device; and
contextual sub-libraries of words communicating with the context analysis system;
the context analysis system being further operative to communicate information corresponding to a first of the contextual sub-libraries to the mobile device responsive to determining that the information corresponding to the text-based communication from the mobile device corresponds to the context of the words included in the first of the contextual sub-libraries.

10. The system of claim 9, further comprising the mobile device.

11. The system of claim 10, wherein:
the mobile device has a user interface, a predictive text engine and a library of words;
the user interface is operative to receive user input corresponding to the text-based communication; and
the predictive text engine is operative to predict text being input via the user interface based, at least in part, on information contained in the library of words and supplemented by the first of the contextual sub-libraries.

12. The system of claim 9, wherein the first of the contextual sub-libraries contains words associated with a technical field.

13. A method for predicting text in a mobile device comprising:
receiving a user input corresponding to a text-based communication;
determining a context of the text-based communication;
requesting, via a communications network, information corresponding to the context; and
predicting text corresponding to the user input based, at least in part, on the information corresponding to the context and received responsive to the request.

14. The method of claim 13, wherein receiving the user input comprises receiving the user input via a user interface of the mobile device.

15. The method of claim 13, wherein determining the context of the text-based communication is performed by the mobile device.

16. The method of claim 13, wherein determining the context of the text-based communication further comprises identifying a word in the text-based communication and associating the word with the context.

17. The method of claim 13, wherein requesting information corresponding to the context comprises requesting access to a sub-library of words associated with the context.

18. The method of claim 13, wherein:
the mobile device comprises a library of words accessible by a text prediction engine; and
the method further comprises updating the library of words responsive to the requesting of information corresponding to the context.

19. The method of claim 18, wherein, in updating the library of words, the library is updated with the information corresponding to the context.

20. The method of claim 19, wherein the library is temporarily updated with the information corresponding to the context.
